(19) United States
(12) Patent Application Publication
(10) Pub. No.: US 2026/0142476 A1
(43) Pub. Date: May 21, 2026

(54) PHOTOVOLTAIC SOLAR TRACKER ASSEMBLY

(71) Applicant: SOLTEC INNOVATIONS, S.L., Molina de Segura (ES)

(72) Inventors: Samir CHAOUKI ALMAGRO, Molina de Segura (ES); Alejandro CARDONA VÉLEZ, Molina de Segura (ES); Ignacio MELÓN MENÉNDEZ, Molina de Segura (ES); Juan José PUERTA MUÑOZ, Molina de Segura (ES); Francisco Javier TORRANO CARRILLO; Marta GARCÍA VIVANCOS, Molina de Segura (ES)

(73) Assignee: SOLTEC INNOVATIONS, S.L., Molina de Segura (ES)

(21) Appl. No.: 18/280,263

(22) PCT Filed: Aug. 9, 2023
(86) PCT No.: PCT/ES2023/070506

§ 371 Date: Sep. 4, 2023

(51) Int. Cl. H02J 7/35; G05D 3/10; H02J 7/00; H02J 7/34; H02J 7/50; H02J 7/82; H02J 101/24; H02S 10/20; H02S 20/32

(52) U.S. Cl. CPC H02J 7/35; G05D 3/105; H02J 7/345; H02J 7/575; H02J 7/82; H02J 7/855; H02S 10/20; H02S 20/32; H02J 2101/25; H02J 2207/50

(57) ABSTRACT

An assembly includes one or more photovoltaic solar trackers; a rechargeable power supply system, including power supply elements to power the tracker or trackers; a charging system, to recharge the power elements; and a tracker controller. The assembly stands out for including one or more supercapacitors as power supply elements. The invention makes it possible to arrange the power supply elements at low temperatures without the need for heaters, increase their useful life and reduce their size.

### CROSS REFERENCE TO RELATED APPLICATION

This application is a national stage under 35 U.S.C. § 371 of PCT patent application PCT/ES2023/070506 filed on 9 Aug. 2023, which is pending and which is hereby incorporated by reference in its entirety for all purposes.

### FIELD OF THE INVENTION

The invention is directed to solar energy, in particular, in that of photovoltaic solar trackers. More specifically, the invention is directed to a photovoltaic solar tracker assembly that allows the operation of the tracker at low temperatures, in particular, below 0° C., as well as a method of controlling the tracker assembly.

### BACKGROUND OF THE INVENTION

In the current state of the art, so-called “self-powered” solar trackers are powered by one or more rechargeable batteries, mainly Lithium-based, such as LiFePO4 technology. These batteries act as an energy reservoir that provides enough energy for the movement and control of the trackers. In turn, these batteries are generally charged with energy from solar panels arranged on the tracker itself, which can have different configurations: one or more solar panels dedicated exclusively to powering the tracker control electronics, or several solar panels forming a generation string from which a portion of energy is extracted to power the tracker control electronics.

The use of batteries, specifically (although not exclusively), of the LiFePO4 type, presents a series of drawbacks, among which are:
The process of charging and discharging the batteries must be limited at temperatures below 0° C., being disabled at temperatures below −10° C. if auxiliary heating elements are not available;
The useful life of the batteries is mainly influenced by the charging time, depth of discharge and the temperature of use, such that very deep discharges reduce the useful life, which oversizes the number of batteries required and/or increases the time required to charge the batteries.

### SUMMARY OF THE INVENTION

The present invention presents a solar tracker assembly.

The solar tracker assembly according to the present invention is based on the use, as a rechargeable power supply system, of supercapacitors, i.e., capacitors with high or very high energy density compared to conventional capacitors, such as supercapacitors with Electrolytic Double Layer Capacitor or EDLC technology and supercapacitors with lithium hybrid technology (Li—C), not being restricted to these technologies. These supercapacitors allow charges or discharges with currents of 200 A or even higher, or capacities between 300 F and 3000 F per cell, even higher.

The following advantages of the assembly of the invention are highlighted.
It allows working below 0° C., for example, in a temperature range from −40° C. to +55° C., without requiring the use of heating means to heat the power supply system. Therefore, the use of supercapacitors eliminates, at least mitigates, the limitations presented by the batteries, particularly LiFePO4 batteries, which require temperatures above 0° C., or said heating means to work in optimal conditions.
Moreover, supercapacitors allow charge and discharge cycles of the order of a million cycles, not being as affected by deep discharges, even 100% discharges, as is the case with batteries, such as LiFePO4 batteries. This allows a theoretical use of 100% of the energy of the supercapacitors in each discharge, although in practice it can be reduced, for example, to 90%, depending on the limitations established by the power electronics.

### BRIEF DESCRIPTION OF THE FIGURES

The advantages mentioned above, as well as other advantages and features of the present invention, will be better understood with reference to the following detailed description of preferred embodiments with reference to the attached figures, which must be considered as illustrative, not limiting, and in which:

FIG. 1 shows a schematic view of the assembly of the invention, in a more general embodiment.

FIG. 2 shows a schematic view of an embodiment of the assembly of FIG. 1, where the recharge is in parallel and the discharge is in series.

### LIST OF REFERENCES

1 Supercapacitors
2 Generation panels
3 Dedicated charging panels
4 Tracker controller
5 Maximum Power Point Tracking (MPPT) system
6 DCDC Regulators
7 Charge management systems

### DETAILED DESCRIPTION OF A PREFERRED EXEMPLARY EMBODIMENT OF THE INVENTION

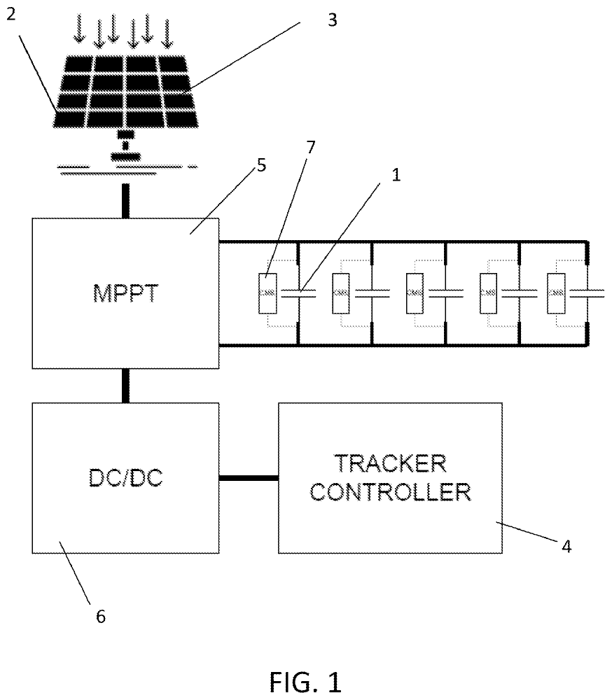

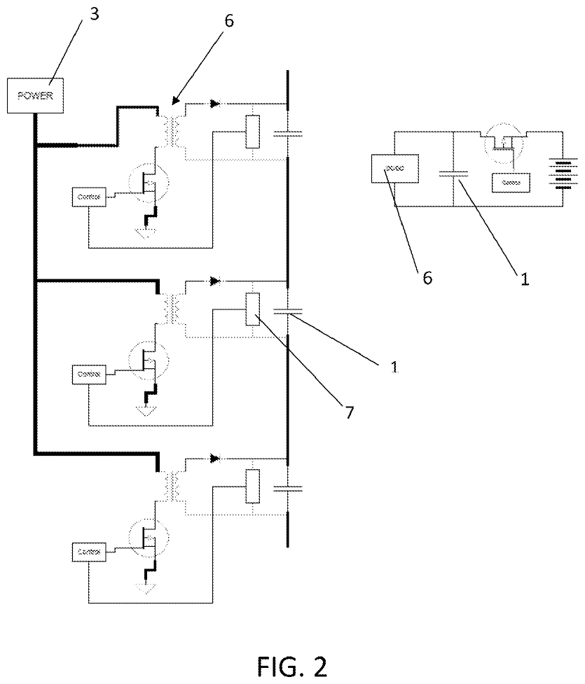

A detailed description of a preferred embodiment of the present invention is given below, with the aid of the aforementioned attached FIGS. 1-2.

The invention relates to a photovoltaic solar tracker assembly. The assembly of the invention comprises: one or more photovoltaic solar trackers; a rechargeable power supply system, including energy storage elements (1), to power the functions of the tracker (such as control and rotation); a charging system, to recharge the energy storage elements (1); and a tracker controller (4).

Each of the trackers comprises photovoltaic panels, in turn including one or more dedicated charging panels (3), which are part of the charging system, since they are intended to charge the energy storage elements (1); in addition to generation panels (2), intended for electricity generation from the photovoltaic plant.

The power system includes, as energy storage elements (1), one or more supercapacitors (1), although optionally a hybrid solution can be considered further including one or more rechargeable batteries (not shown), such as LiFePO4. Through the hybrid solution, for example, with one or two supercapacitors (1) and one or more batteries, the total cost is optimised, being able to use the supercapacitors (1) in normal operation, including absorption of current peaks, and the batteries remain in floating mode to serve as support when it is required to adopt the defence position, which increases the useful life of the batteries.

The charging system includes charging sources, such as, preferably, the dedicated charging panels (3) referred to above, although, additionally, even alternatively, it may include other charging sources, such as charging through extraction of energy from one or more strings of the generation panels, both in series and, where appropriate, in parallel. In the photovoltaic sector, “string” is understood as an assembly of photovoltaic solar panels that are connected in series to jointly provide energy.

The charging system can additionally include a maximum power point tracking system (5) (MPPT).

Also, optionally, mainly in the event that the power system does not incorporate batteries, but only supercapacitors (1), the charging system can include, additionally or alternatively, one or more DC/DC regulators (6), which adapt the voltage of the supercapacitor (1), which tends to vary significantly as it discharges, to provide the controller (4) with voltage within predetermined acceptable limits.

Preferably, the supercapacitor (1), or each one of the supercapacitors (1), is connected to the charging system and, where appropriate, some supercapacitors (1) are connected to others, so that the recharge of the supercapacitors (1) can be a recharge in series. Likewise, also preferably, the supercapacitors (1) are connected to the charging system, as well as, where appropriate, some supercapacitors (1) are connected with others, so that the recharge of the capacitors (1) is a recharge in parallel. Even more preferably, the connections allow the recharge to be selectable between a recharge in series or a recharge in parallel.

In the cases in which recharging in series is selected, i.e., with the supercapacitors (1) connected in series with one another, the MPPT system (5) acts to make the charging system work (for example, the corresponding dedicated panel or panels), at maximum power and, therefore, inject the supercapacitor (1) with maximum current, which allows a recharge of the supercapacitor (1) in a short time. More specifically, depending on the voltage of the dedicated charging panel (or panels) (3), the charging current can be in an approximate range of between 25 A if the supercapacitors (1) are fully discharged, and 3.5 A if they are fully charged.

For the cases in which a recharge in parallel is chosen, the supercapacitors (1) are connected such that they can be independently recharged; each one, or each group of them, with its charging source, such as its dedicated charging panel (3), for example. In this way, it is also possible to inject maximum current to each supercapacitor (1) in the case of using a power source other than dedicated charging panels (3).

In order for the voltage in the supercapacitors (1) not to exceed a predetermined upper limit during recharging, particularly in the case of recharging in series, one or more charge management systems can also be included in the charging system (7), which act as protection for the supercapacitors (1) that are placed in series.

In view of the foregoing, according to a preferred embodiment of the invention, the discharge of the supercapacitors (1) occurs in series and the recharge in parallel, so that the recharge in parallel has the advantage of acting as a charge management system (7). More specifically, the isolated DC/DC regulators (6) can be arranged powering each supercapacitor (1) with the required current and voltage, and with the ability to detect voltage values greater than a predetermined threshold value.

In normal operation and preferably, the tracker is powered by the dedicated charging panel or panels (3), together with the supercapacitors (1). In this way, ideally, the supercapacitors (1) hardly discharge and are always in a state of charge close to 100%.

1.-11. (canceled)

12. A photovoltaic solar tracker assembly comprising:
one or several photovoltaic solar trackers;
a rechargeable power supply system, which includes energy storage elements to power the tracker or trackers;
a charging system, to recharge the energy storage elements; and
a tracker controller;
wherein the energy storage elements comprise one or more supercapacitors.

13. The photovoltaic solar tracker assembly according to claim 12, wherein the energy storage elements consist of one or more supercapacitors.

14. The photovoltaic solar tracker assembly according to claim 12, wherein the energy storage elements comprise one or more supercapacitors and one or more rechargeable batteries,
wherein the rechargeable batteries are LiFePO4 batteries.

15. The photovoltaic solar tracker assembly according to claim 12, wherein the charging system includes a maximum power point tracking system, MPPT, to bring the charging system to operation at maximum available recharge power, injecting the energy storage elements with maximum available power.

16. The photovoltaic solar tracker assembly according to claim 12, wherein the supercapacitor or the supercapacitors are connected to the charging system and, where appropriate, some supercapacitors are connected to others, to be recharged in series.

17. The photovoltaic solar tracker assembly according to claim 12, wherein the supercapacitor or the supercapacitors are connected to the charging system and, where appropriate, some supercapacitors are connected to others, to be recharged in parallel.

18. The photovoltaic solar tracker assembly according to claim 17, wherein the recharge is carried out in parallel, the supercapacitor or the supercapacitors are connected to be independently recharged, allowing injection of maximum current to each supercapacitor.

19. The photovoltaic solar tracker assembly according to claims 17, wherein the supercapacitor or the supercapacitors can be connected to be discharged in series and charged in parallel.

20. The photovoltaic solar tracker assembly according to claim 19, which additionally includes isolated DC/DC regulators powering each supercapacitor with the required current and voltage, and with the ability to detect voltage values greater than a predetermined threshold value.

21. The photovoltaic solar tracker assembly according to claim 15, wherein the supercapacitor or the supercapacitors are connected to the charging system and, where appropriate, some supercapacitors are connected to others, to be recharged selectively in series or in parallel.

22. The photovoltaic solar tracker assembly according to claim 12, which additionally includes, for each supercapacitor or group of supercapacitors, a charge management system, so that, during recharging, each supercapacitor does not exceed a predetermined upper limit voltage value.
